(19) United States
(12) Patent Application Publication
(10) Pub. No.: US 2014/0223697 A1
(43) Pub. Date: Aug. 14, 2014

(54) Removable Hardware Structure

(71) Applicant: Christopher M. Draeger, Hortonville, WI (US)

(72) Inventor: Christopher M. Draeger, Hortonville, WI (US)

(73) Assignee: CRE8TIVE HARDWARE, INC., Neenah, WI (US)

(21) Appl. No.: 14/173,013

(22) Filed: Feb. 5, 2014

Related U.S. Application Data
(60) Provisional application No. 61/763,220, filed on Feb. 11, 2013.

(51) Int. Cl. F16B 47/00

(52) U.S. Cl. CPC F16B 47/00; F16B 47/003
USPC 24/303; 24/304; 156/281; 29/428

(57) ABSTRACT

A removable hardware structure and method are provided. The removable hardware structure does not require drilling, riveting, or otherwise damaging a mounting surface that will receive the decorative hardware element. The removable hardware structure includes a hardware element and an attachment element for securing the hardware element to a portion of a mounting surface. The attachment element is configured such that securing the hardware element to the portion of the mounting surface does not require puncturing the portion of the mounting surface.

### CROSS-REFERENCE TO RELATED PATENT APPLICATIONS

This patent application claims the benefit of U.S. Provisional Patent Application No. 61/763,220, filed Feb. 11, 2013, the entire teachings and disclosure of which are incorporated herein by reference thereto.

### FIELD OF THE INVENTION

This invention generally relates to removable hardware structures utilized in residential settings, and more particularly to removable hardware structures used on doors.

### BACKGROUND OF THE INVENTION

There is a growing trend of decorating residential doors such as garage doors or entry doors with certain hardware elements that are decorative, e.g. handles, hinge plates, etc. One typical location for these decorative elements is the garage door. The inclusion of such elements ordinarily requires fixing such elements to an outer surface of the door using screws, rivets, or the like.

Unfortunately, over time such hardware elements can become damaged, or alternatively, become undesirable due to changes in decorating preferences. However, once these elements are removed, a hole or holes in the outer surface of the door they were associated with remains. This hole is a result of the mounting hardware, e.g. screws, rivets, etc. used to mount the decorative element to the door. Given that the outer wall of the door is very thin, the hole often times becomes misshapen, and thus cannot properly accommodate a replacement fastener of a new decorative hardware element. As a result, using this existing misshapen mounting hole results in a loose fit of the new decorative hardware element to the door, which is not in any way desirable. Further, even where a replacement decorative element is not desired, the misshapen hole is not readily patchable so as to conceal it.

To eliminate the aforementioned problems, installers typically replace the entire door, or a section thereof, so that new holes may be created using screws, rivets, etc. to fixedly attach a new decorative hardware element, or so that the previous holes are eliminated in instances where replacement decorative hardware elements will not be utilized. Such a process is relatively very costly and labor intensive. Accordingly, there is a need in the art for a decorative hardware element that does not require drilling, riveting, or otherwise damaging a door to mount the same.

The invention provides such a decorative hardware element included in a hardware structure. These and other advantages of the invention, as well as additional inventive features, will be apparent from the description of the invention provided herein.

### BRIEF SUMMARY OF THE INVENTION

In one aspect, the invention provides a removable hardware structure comprising a hardware element and attachment element. The removable hardware structure does not require drilling, riveting, or otherwise damaging a mounting surface that will receive the removable hardware structure.

An embodiment of a removable hardware structure includes a hardware element and an attachment element for securing the hardware element to a portion of a mounting surface. The attachment element is configured such that securing the hardware element to the portion of the mounting surface does not require puncturing the portion of the mounting surface.

The hardware element of the removable hardware structure has a top surface and a bottom surface. The top surface provides for at least one protrusion and the bottom surface provides for at least one recess. In certain embodiments the at least one protrusion may take the form of the top of a screw.

The attachment element in an embodiment may be magnetic, while in yet others it may be an adhesive pad, while in still others it may be an adhesive pad or in still further embodiments it may be an adhesive.

Another embodiment of the present invention provides for a removable hardware structure comprising a hardware element that has a top surface and a bottom surface. The removable hardware structure is further comprised of an attachment element for securing the hardware element to an aperture-free portion of a mounting surface. The attachment element is positioned in a recess which extends into the bottom surface of the hardware element. The attachment element is configured to secure the hardware element to the aperture-free portion of the mounting surface. In certain embodiments the hardware element may be metal and may be handle shaped or a hinge plate.

The bottom surface of the hardware element defines at least one blind hole. The top surface may comprise at least one protrusion in the form of a top of a screw that extends from the top surface of the hardware element. In certain embodiments each of the at least one blind holes may be axially aligned with each of the at least one protrusions. Other embodiments may provide for a magnetic attachment element. In yet other embodiments the attachment elements may be an adhesive pad. In still other embodiments the attachment element is an adhesive.

Another inventive aspect of the present invention provides a method for installing a removable hardware structure. The method is comprised of the steps of cleaning a portion of a mounting surface to free the surface from loose debris and dust. In the next step a bottom surface of the hardware element with an attachment element is fixed to the portion of the mounting surface. The fixation is done so as to leave the portion of the mounting surface in an aperture free condition. In certain embodiments of the method the removable hardware structure is a hinge plate. In other embodiments the removable hardware structure is handle shaped. In yet other embodiments the attachment element may be magnetic while in still others the attachment element may be an adhesive.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a front view of a door with exemplary embodiments of removable hardware structures according to the teachings of the present invention installed thereon;

FIG. 2 is a front view of another door with the removable hardware structures of FIG. 1 installed thereon;

FIGS. 3-5 are top, side, and bottom views, respectively of one removable hardware structure of FIG. 1;

FIGS. 6-8 are top, side, and bottom views, respectively of another removable hardware structure of FIG. 1; and

FIG. 9 is a sectional view taken through section line A-A shown in FIG. 7.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

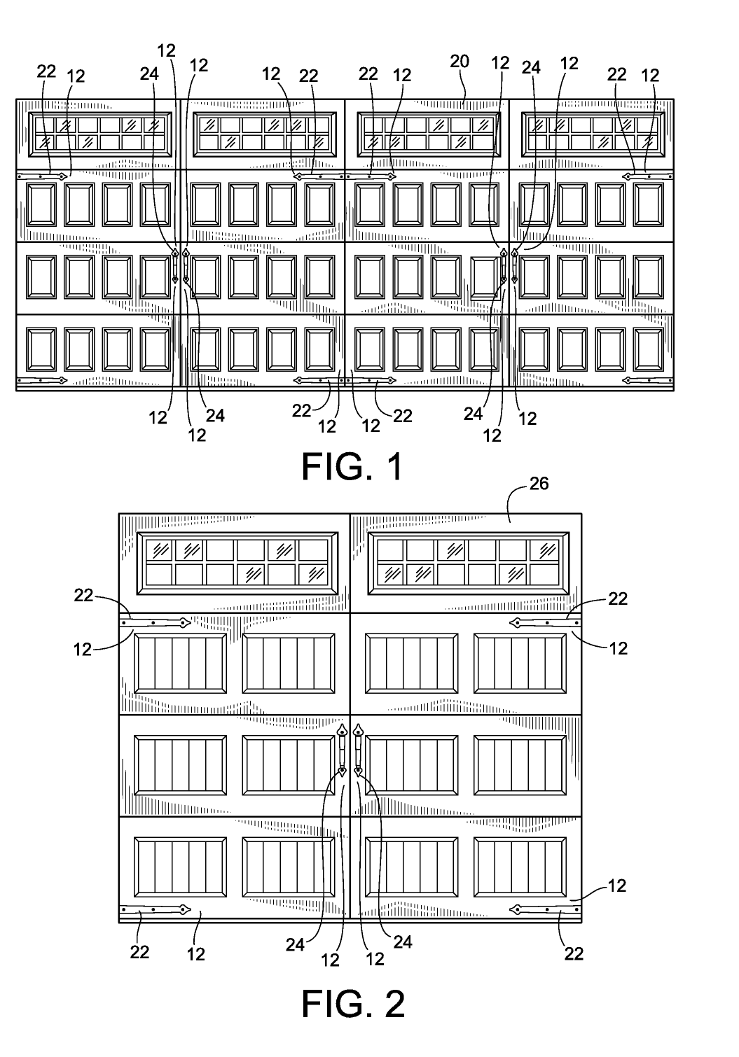

Turning now to the drawings, several embodiments of a removable hardware structure according to the teachings of the present invention are illustrated. With specific reference to FIG. 1, an exemplary illustration of a garage door 20 is illustrated. Removable hardware structures 22, 24 are situated on garage door 20 and more specifically on a portion of the door 20 that provides an aperture free mounting surface 12 for the removable hardware structure 22 as illustrated. This mounting portion remains aperture free even after detachment of the removable hardware structure 22.

Garage door 20 opens vertically, however, the arrangement of removable hardware structures 22, 24 give the impression that garage door 20 has two separate side opening entryways. Indeed, removable hardware structure 22 is in the form of a hinge plate while removable hardware structure 24 is in the form of a handle. This arrangement gives the impression of side opening doorways as opposed to a vertically opening garage door characteristic of garage door 20 illustrated in FIG. 1.

Turning now to FIG. 2, a smaller scale door 26 is illustrated. Removable hardware structures 22, 24 are arranged on a portion of the door 26 that provides an aperture free mounting surface 12 for the removable hardware structure 22 to once again give the impression of a side opening door as opposed to a vertically opening door. Unlike prior designs, and as will be explained in greater detail below, removable hardware structures 22, 24 illustrated in FIGS. 1 and 2 advantageously do not require drilling or puncturing the mounting surface 12 of doors 20, 26 to affix removable hardware structures 22, 24 thereto. As a result, if any one of removable hardware structures 22, 24 becomes damaged, the same can be easily replaced without also needing to replace a section of either of doors 20, 26. While the following description will discuss aspects of the present invention in the context of the specific embodiments of removable hardware structures 22, 24 and doors 20, 26, those skilled in the art will immediately recognize that removable hardware structures 22, 24 can take on a variety of shapes and be utilized with a variety of doors. As such, the invention herein is not in any way limited by the particular shape or aesthetic features of removable hardware structures 22, 24, or doors 20, 26 that removable hardware structures 22, 24 are associated with.

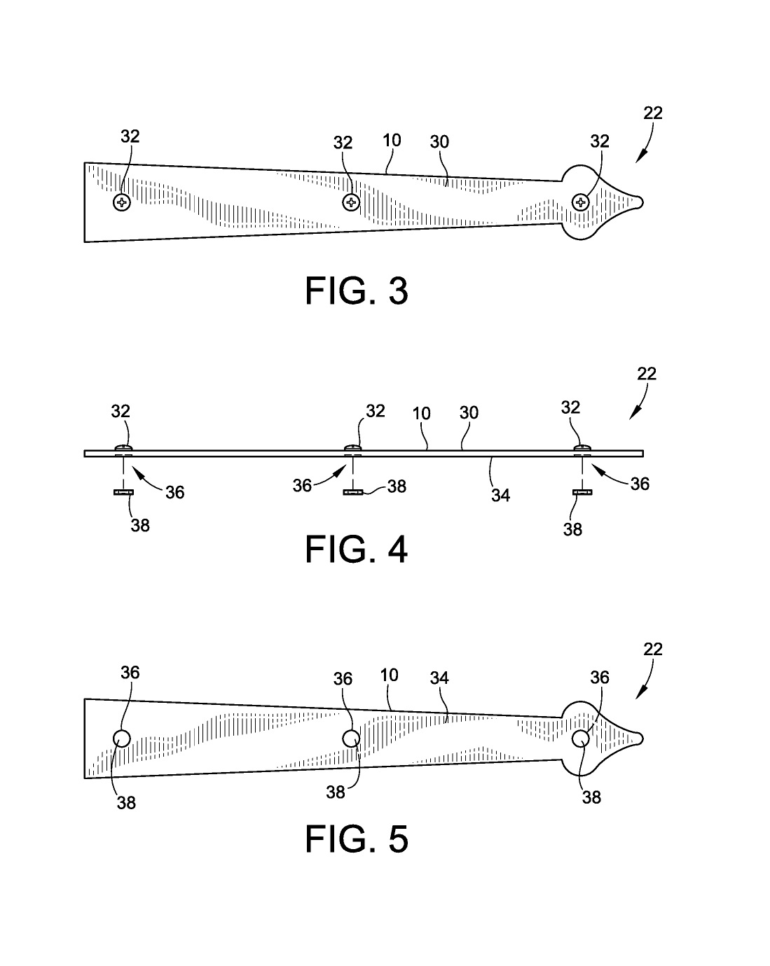

Turning now to FIGS. 3-5, removable hardware structure 22 will be described in greater detail. As stated above, decorative hardware element 22 is illustrated as a hinge plate. With specific reference to FIG. 3, removable hardware structure 22 includes a hardware element 10 that has a top surface 30 with a plurality of protrusions 32 extending therefrom. Protrusions 32 generally take the form of the top of a screw to give the impression that screw-type hardware is used to affix hardware element 10 to its associated surface. However, and turning now to FIG. 4, rather than actually utilize screws or the like, hardware element 10 incorporates a plurality of recesses 36 extending into a bottom surface 34 of hardware element 10. As shown, these recesses 36 are generally aligned with protrusions 32, however, in other embodiments such alignment may not exist. Recesses 36 are illustrated as blind holes, and are arranged to receive attachment elements 38. Attachment elements 38 may take the form of any type of magnet, any type of adhesive pad, or any type/formulation of adhesive. The shape of recesses 36 are matched to the shape of attachment elements 38 so that when attachment elements 38 are positioned within recesses 36 they are flush with bottom surface 34 of hardware element 10 such that a smooth and flat attachment surface is presented. Turning now to FIG. 5, the bottom surface 34 of hardware element 10 is illustrated. As can be seen in this view, recesses 36 are generally circular in shape. However, depending on the shape and configuration of the attachment elements 38 used with decorative hardware element 22, recesses 36 may take on other shapes such as rectangular slots or the like. As such, the particular illustrated shape of recesses 36 are not in any way limiting on the invention.

As stated above, attachment elements 38 may be magnetic, take the form of an adhesive pad, also, attachment elements 38 may be embodied as an amount of adhesive situated in recesses 36. Those skilled in the art will recognize that various types of magnets, adhesive pads, and/or adhesives may be utilized for attachment elements 38. Whichever one or combination of attachment elements 38 are utilized, it will be recognized that the same provide for a non-permanent and non-destructive means for attaching removable hardware structure 22 to a door or other surface such as that illustrated by mounting surface 12 of doors 20, 26 shown in FIGS. 1 and 2. Indeed, in the context of magnetic attachment elements 38, the same may be utilized to non-permanently attach removable hardware structure 22 to either of doors 20, 26 shown in FIGS. 1 and 2 respectively. The magnetic force provided by these magnetic attachment elements 38 is strong enough to fix the positioning of removable hardware structure 22 on normal operating conditions, but will allow for the removal of removable hardware structure 22 without damage to either of doors 20, 26 or their mounting surfaces 12 for purposes of replacement or relocation. This same functionality holds true of adhesive pads and/or adhesives are used for attachment elements 38. In such a configuration, the adhesive utilized may be strong enough to fix the position of decorative hardware element 22 against doors 20, 26 respectively shown in FIGS. 1 and 2, but will also allow for the removal of decorative hardware element 22 without damage to doors 20, 26 respectively shown in FIGS. 1 and 2.

The attachment elements 38 further provide an advantageous safety feature. That is, with a garage door 20, 26 in the closed position, it may come to pass that a child grasps the hardware element 10 on the outside of the garage door while unbeknownst to the child, from inside the garage, the door may be actuated to open. In such an instance, because the hardware element 10 is removable, as the door lifts, the child will not be carried up with the door because the removable hardware structure 22, 24 cannot support the weight of the child. As such, the hardware structure 22 detaches from the mounting surface of the garage door and thus preventing the child from being lifted with the door.

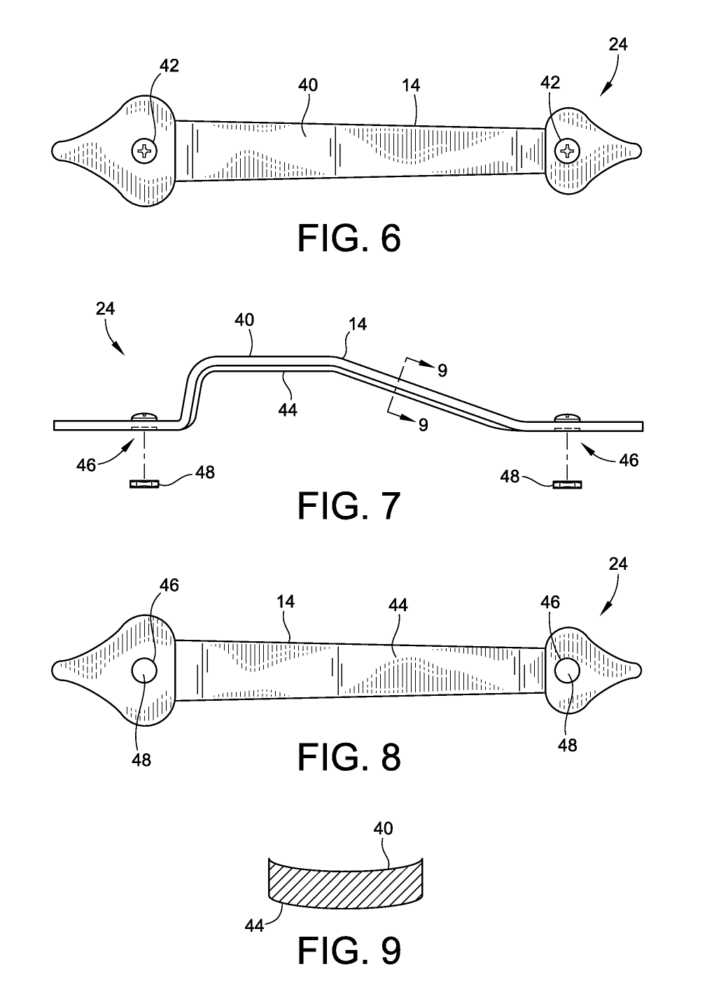

FIGS. 6-9 illustrate decorative hardware structure 24, which in the illustrated embodiment takes the form of a handle-shaped element. With particular reference to FIG. 6, removable hardware structure 24 includes a hardware element 14 that has a top surface 40 with protrusions 42 extending therefrom. As was the case with removable hardware structure 22, protrusions 42 take the shape of screws to give the impression of conventional screw-type attachment of hardware structure 24. However, and with reference to FIG. 7, removable hardware structure 24 includes a plurality of recesses 46 formed on a bottom surface 44 of hardware element 14 for receiving attachment elements 48. Attachment elements 48 are the same as those contemplated above relative to removable hardware structure 22. With reference to FIG. 8, recesses 46 are generally circular blind holes, however, they may take on any shape necessary to accommodate the particular attachment element 48 utilized therewith so as to present a smooth, flat attachment surface for mounting decorative hardware element 14 to a mounting surface 12 that is aperture free and flat such as that shown by way of doors 20, 26 in FIGS. 1 and 2 respectively. FIG. 9 illustrates a cross-section of removable hardware structure 24 taken through section line A at FIG. 7. As can be seen in this view, this portion of hardware structure 24 does not have a generally flat surface as it is not utilized for mounting. As such, aesthetic curved effects may be implemented thereon as shown.

As introduced above, removable hardware structures 22, 24 advantageously allow for the attachment thereof to a door such as doors 20, 26 respectively shown in FIGS. 1 and 2 without the need to drill or otherwise damage the outer surface of doors 20, 26. Such functionality is achieved by incorporating recesses 36, 46 and attachment elements 38, 48 on a bottom surface 34, 44, respectively, of hardware elements 10, 14.

Removable hardware structures 22, 24 may be supplied with attachment elements 38, 48 already installed in recesses 36, 46 of hardware elements 10, 14. Alternatively, the hardware elements 10, 14 of removable hardware structures 22, 24 may simply be supplied with recesses 36, 46 for subsequent introduction of attachment elements 38, 48 at an installation site. Hardware elements 10, 14 may be formed from a variety of materials including but not limited to metals, plastics, and/or composites. Methods of manufacturing hardware elements 10, 14 may include machining, injection molding, casting, etc.

As described above, removable hardware structures 22, 24 advantageously overcome prior designs by utilizing non-permanent, non-damaging attachment means for affixing the same to a surface. As a result, to the extent that a user chooses to replace or relocate removable hardware structures 22, 24 such replacement and relocation may be achieved without also replacing or repairing a section of door at which removable hardware structure 22 or removable hardware structure 24 was previously located at.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A removable hardware structure comprising:
a hardware element;
an attachment element for securing the hardware element to a portion of a mounting surface;
wherein the attachment element is configured such that securing the hardware
element to the portion of the mounting surface does not require puncturing the portion of the mounting surface.

2. The decorative hardware element of claim 1, wherein the hardware element further comprises a top surface and a bottom surface.

3. The removable hardware structure of claim 2, wherein the hardware element is further comprised of at least one protrusion on the top surface and at least one recess on the bottom surface.

4. The removable hardware structure of clam 3, wherein the at least one protrusion takes the form of the top of a screw.

5. The removable hardware structure of clam 1, wherein the attachment element is magnetic.

6. The removable hardware structure of clam 1, wherein the attachment element is an adhesive pad.

7. The removable hardware structure of clam 1, wherein the attachment element is an adhesive.

8. A removable hardware structure comprising:
a hardware element comprising a top surface and a bottom surface;
an attachment element for securing the hardware element to an aperture-free portion of a mounting surface; the attachment element positioned in a recess which extends into the bottom surface; and
wherein the attachment element is configured to secure the hardware element to the aperture-free portion of the mounting surface.

9. The removable hardware structure of claim 8, wherein the hardware element is metal.

10. The removable hardware structure of claim 8, wherein the hardware element is handle shaped or a hinge plate.

11. The removable hardware structure of claim 8, wherein the bottom surface defines at least one blind hole and the top surface comprises at least one protrusion in the form of a top of a screw extending from the top surface.

12. The removable hardware structure of claim 11, wherein each of the at least one blind holes is axially aligned with each of the at least one protrusions.

13. The removable hardware structure of clam 11, wherein the attachment element is magnetic.

14. The removable hardware structure of clam 11, wherein the attachment element is an adhesive pad.

15. The removable hardware structure of clam 11, wherein the attachment element is an adhesive.

16. A method for installing a removable hardware structure, the method comprising the steps of:
cleaning a portion of a mounting surface to free the surface from loose debris and dust;
fixing a bottom surface of a hardware element with an attachment element to the portion of the mounting surface such that the fixation leaves the portion of the mounting surface in an aperture free condition.

17. The method of claim 16, wherein the removable hardware structure is a hinge plate.

18. The method of claim 16, wherein the removable hardware structure is handle shaped.

19. The method of claim 16, wherein the attachment element is magnetic.

20. The method of claim 16, wherein the attachment element is an adhesive.
